(19) United States
(12) Patent Application Publication
(10) Pub. No.: US 2006/0103884 A1
(43) Pub. Date: May 18, 2006

(54) Printing method and apparatus

(75) Inventors: Myoung-jin Oh, Suwon-si (KR); Jae-kyoo Kang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/273,022

(22) Filed: Nov. 15, 2005

(30) Foreign Application Priority Data
Nov. 15, 2004 (KR) 10-2004-0093090

(51) Int. Cl. H04N 1/40

(52) U.S. Cl. 358/3.28

(57) ABSTRACT

A printing method and apparatus is provided which can allocate an identification code and additional information to respective files to enable separate processing of the files according to the designated additional information. Accordingly, specific files can be facilely selected from among a mass of files, and further, the selected files can be separately processed according to the additional information.

### CROSS-REFERENCE TO RELATED APPLICATIONS

This application claims the benefit under 35 U.S.C. §119(a) of Korean Patent Application No. 10-2004-0093090, filed in the Korean Intellectual Property Office on Nov. 15, 2004, the entire disclosure of which is incorporated herein by reference.

### BACKGROUND OF THE INVENTION

1. Field of the Invention

The present invention relates to a printing method and apparatus. More particularly, the present invention relates to a method for enabling a plurality of users to easily select a desired file and process the desired file separately, by adding an identification code to thumbnail data.

2. Description of the Related Art

As digital cameras have become more widespread, a growing number of images are now more easily photographed, obtained, and preserved by a personal computer (PC). A user can easily print these images out or send electronic mail (e-mail) with the images attached.

Accordingly, software for image management has been developed to enable, for example, the printing and attachment of the images to e-mail through the PC.

FIG. 1 illustrates an exemplary screen for image management. As shown in FIG. 1, upon selecting a folder from section 1 including an image to be displayed, image files in the corresponding folder are displayed in the form of thumbnail, so that the user can preview a number of images at once. When a certain thumbnail from section 2 is selected and double-clicked, the corresponding image can be printed out, as well as enlargedly displayed through a separate window. Also, when a certain thumbnail is selected and designated for “e-mail transmission”, mailing software is driven to automatically attach an image file corresponding to the selected thumbnail to an e-mail.

FIG. 2 illustrates an example of a print designation window.

By selecting a plurality of thumbnails and selecting a “print” menu, a window illustrating a print sheet is displayed as shown in FIG. 2. Here, thumbnail data 60 may be disposed on the left of the sheet, and the row-wise number of frames 40 and the column-wise number of frames 50 of the thumbnail image frames for display on the sheet may respectively be designated by a user. In the example shown in FIG. 2, the row-wise number and the column-wise number of the frames 40 and 50 are set to 1 and 3, respectively. In a case wherein the selected images are to be displayed by more than one sheet, a “previous page” button 10 and a “next page” button 20 are used to check all of the image frames. If a “print” button 30 is selected, printing is performed according to a layout as designated above.

Through such a thumbnail method of display, a mass of images can be seen at once; however, the images are displayed in a size that is too small to be checked in detail.

Therefore, the image management software sometimes comprises a “slide show” function for consecutively displaying the plurality of selected thumbnail data in a full screen. Using the “slide show” function, a first image among the selected images is displayed in a full screen and changed to a next image upon a mouse-click or a key operation. By repeating this, all of the selected images can be displayed in the full screen in series.

After being photographed using a digital camera and saved in the PC, the plurality of images are typically displayed in sizes of 80×60 dots to 162×120 dots, in consideration of a screen size of a conventional PC device.

However, according to the conventional method of thumbnail image display, the user is required to check the images by repeatedly playing the “slide show” to select preferred images for printing or e-mailing, and then remember the preferred images to reselect them after returning to the screen which displays the thumbnail data.

Therefore, it takes a great deal of time and effort to select desired images for printing and e-mailing. In addition, yet another procedure is required to determine printing options such as the number of copies for printing, zoom-in and zoom-out, or to determine additional information for e-mailing, such as a destination address and a sending time, thereby causing more inconvenience to the user.

Accordingly, a need exists for a system and method that allows a user to easily select and process a desired file.

### SUMMARY OF THE INVENTION

An aspect of the present invention is to solve at least the above problems and disadvantages, and to provide at least the other advantages described below. Accordingly, an aspect of the present invention is to provide a printing method for facilely managing a document by printing an image in a thumbnail form and then adding information to a printed paper, and a printing apparatus according to the same.

In order to achieve the above-described and other aspects of the present invention, a printing method is provided comprising the steps of printing out printing information including an additional information indication part for designating certain additional information and a discernable identification code, displaying the additional information in the additional information indication part, reading the additional information and the identification code, and printing out the printing information being discriminated by the identification code according to the additional information.

The discernable identification code may be comprised of a barcode.

The displaying step further comprises a step for selecting one of a plurality of configurable options. More preferably, the plurality of options may comprise a number of copies for printing of the printing information.

The reading step further comprises a step of at least one of scanning the additional information or scanning the barcode identification.

Another aspect of the present invention is to provide a printing apparatus comprising a printing part for printing out the printing information including the additional information indication part for designating certain additional information and a discernable identification code, a reading part for reading the additional information and the identification code, and a control part for printing out the printing information being discriminated by the identification code according to the additional information. The discernable identification code may be comprised of a barcode.

The additional information indication part can further select and display one of a plurality of configurable options. The plurality of options may comprise a number of copies for printing of the printing information.

The reading part can further perform at least one of a scanning of the additional information or a scanning of the barcode identification.

### BRIEF DESCRIPTION OF THE DRAWING FIGURES

The above aspects and other features of the present invention will become more apparent by describing in detail exemplary embodiments thereof with reference to the attached drawing figures, wherein;

FIG. 1 shows an exemplary window screen for image management;

FIG. 2 shows an example of a window screen for setting print options;

FIG. 3 is a schematic block diagram of a multi-function apparatus according to an embodiment of the present invention;

FIG. 4 shows an example of thumbnail data allocated and displayed with an identification code and additional information, respectively, according to an embodiment of the present invention;

FIG. 5 shows another example of thumbnail data allocated and displayed with an identification code and additional information, respectively, according to an embodiment of the present invention;

FIGS. 6A to 6C show tables for managing printing data according to an embodiment of the present invention; and

FIG. 7 is a flowchart for illustrating a method of reading and printing printed thumbnail data according to an embodiment of the present invention.

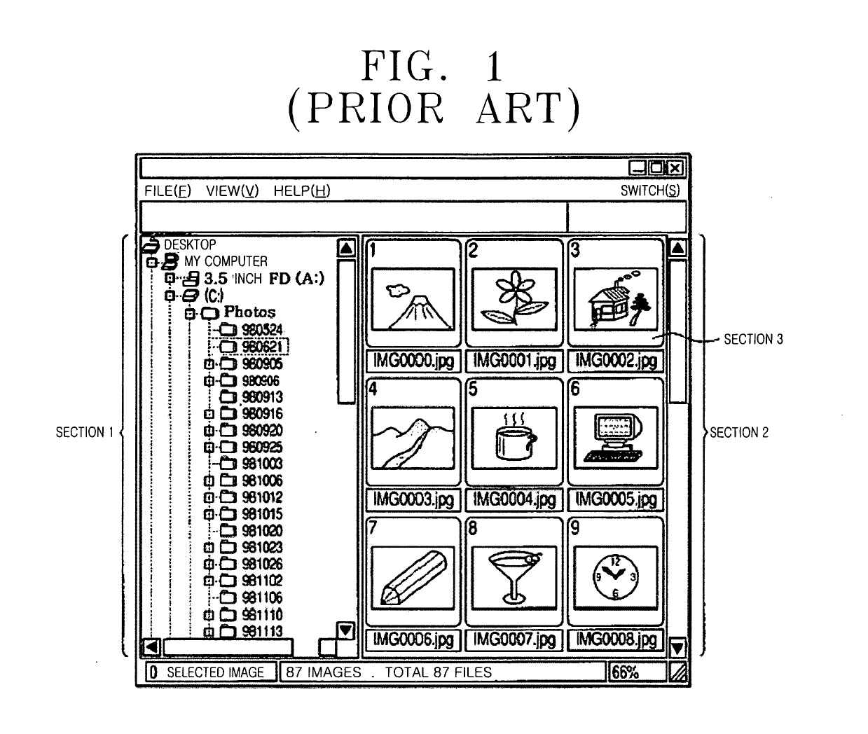

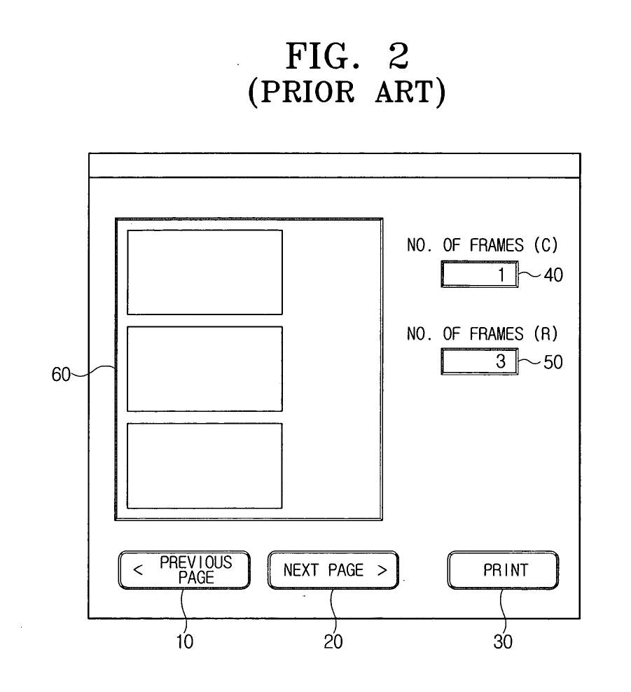

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present invention will be described in detail with reference to the accompanying drawing figures.

In the following description, same drawing reference numerals are used for the same elements even in different drawings. The matters defined in the description, such as detailed construction and element descriptions, are provided to assist in a comprehensive understanding of the invention. Also, functions or constructions that are well known to those skilled in the art are omitted for clarity and conciseness.

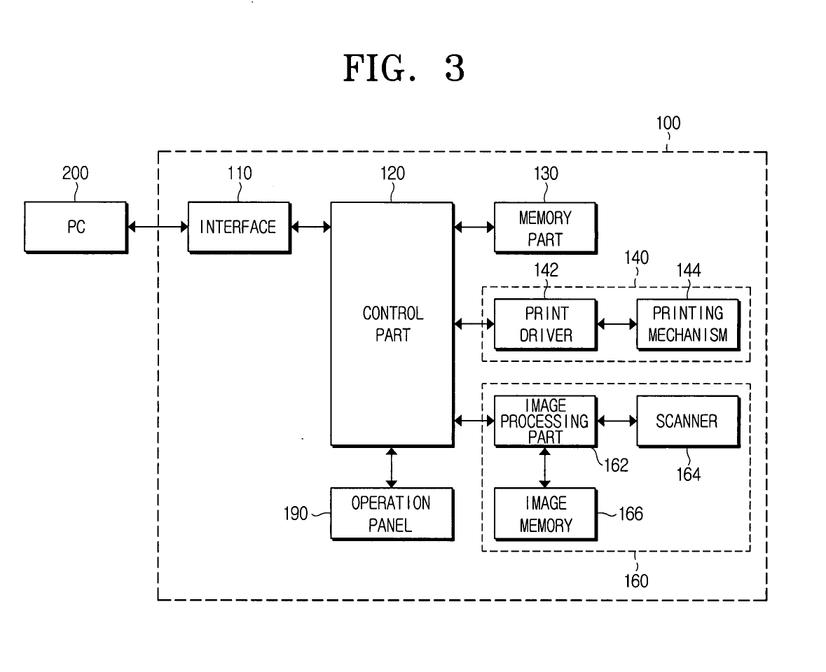

FIG. 3 is a block diagram illustrating a multi-function apparatus according to an embodiment of the present invention.

As shown in FIG. 3, a multi-function apparatus 100 comprises an interface 110, a control part 120, a memory part 130, a printing part 140 including a print driver 142 and a printing mechanism 144, and a reading part 160 including an image processing part 162, a scanner 164, and an image memory 166.

A structure of the printing part 140 according to an embodiment of the present invention will be described in greater detail below.

An operation panel 190 is also provided and comprises an input part having a plurality of keys (not shown) for selecting and setting functions applied by the multi-function apparatus 100, and a display part (not shown) for displaying information on an operation status of the multi-function apparatus 100 according to the control of the control part 120.

The interface 110 is connected between a host computer 200 and the control part 120 so as to interface input/output signals. The interface 110 may adopt an Institute of Electrical and Electronics Engineers (IEEE) 1284 interface, a universal serial bus (USB), an RS232C interface, or the like.

The memory part 130 comprises a read-only memory for storing control programs and application programs to drive the control part 120, and a random-access memory for buffering printing data applied from the host computer 200 through the interface 110 and a variety of data generated during the execution of the programs of the control part 120. The memory part 130 further includes a program for generating a discernable identification code, such as a barcode, and an additional information displaying program for showing additional information so that a user is able to designate printing options, such as the number of copies for printing.

The host computer 200 converts files for printing, such as image files, into thumbnail data and transmits the thumbnail data to the multi-function apparatus 100.

The control part 120 controls the operation of the printing mechanism 144 according to the control programs in the memory part 130, and controls the printing part 140 to display the identification code and the additional information. More specifically, when the thumbnail data for printing is received from the host computer 200 through the interface 110, programs for generating the identification code and for displaying the additional information, which are stored to the memory part 130, are executed to form printing data and generate frame data by adding the identification code and the additional information to the respective thumbnail data. Additionally, color compensation is performed with respect to the data based on a YMCK (yellow-magenta-cyan-black) color system, and the color-compensated data is stored to the memory part 130. The stored data is then converted, according to the colors, to the image data in a bitmap form. When the generation of the bitmap data is completed, a command is transmitted to the printing part 140 to begin printing the work.

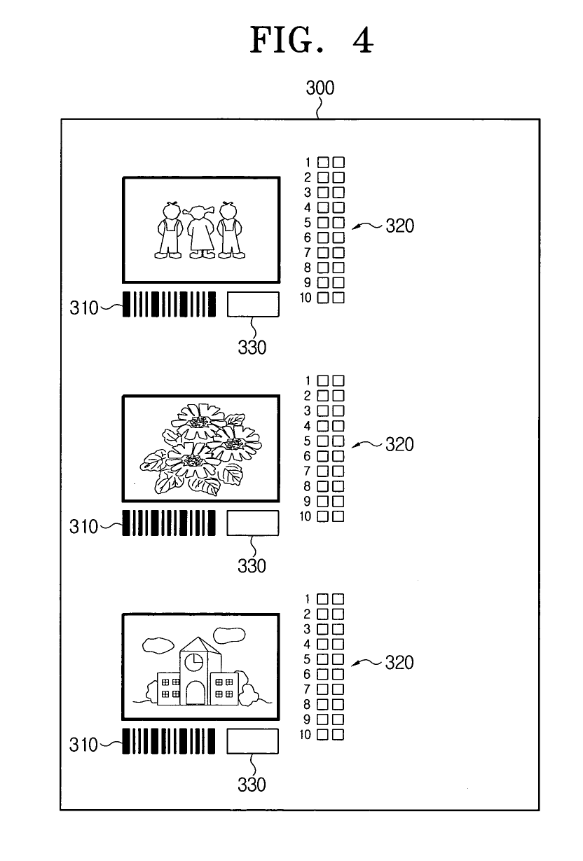

Hereinbelow, a method for displaying the identification code and the additional information will be described in greater detail with reference to FIG. 4. FIG. 4 shows an example of thumbnail data allocated and displayed with an identification code and additional information, respectively, according to an embodiment of the present invention. As the thumbnail data is transmitted from the host computer 200, the control part 120 executes the programs stored in the memory part 130, that is, the programs for generating the identification code and displaying the additional information, such that an identification code 310 in a barcode form is discernibly displayed below the thumbnail data, respectively. The additional information indication part 320 is displayed on the right of the thumbnail data, respectively, to display thereon various conditions configured by a user, such as the number of copies for printing. Also, a file name 330 can be additionally displayed at a certain position below the thumbnail data.

The identification code 310 is not limited to the barcode form shown in FIG. 4, and in yet other embodiments of the present invention, can be comprised of serial numbers allocated to the respective image data to discriminate among one another. Alternatively, locations of each image data may be initially selected so that the image data can be later identified by the location information. For example, each image data may be allocated with a certain (x, y) coordinate, and location information based on the coordinate is kept in a memory. The location of each image data can be identified by reading the (x, y) coordinate displayed on the additional information indication part 320. In a case wherein the identification code 310 has a barcode form, a dedicated barcode reader can be adopted to read the barcode and thereby identify location information of each image data. The additional information indication part 320 can display diverse information related to general printing options comprising zoom-in/zoom-out, paper type and paper orientation, number of copies for printing, and so forth. The additional information indication part 320 preferably comprises indication blanks for a user to mark for the selection of the printing options.

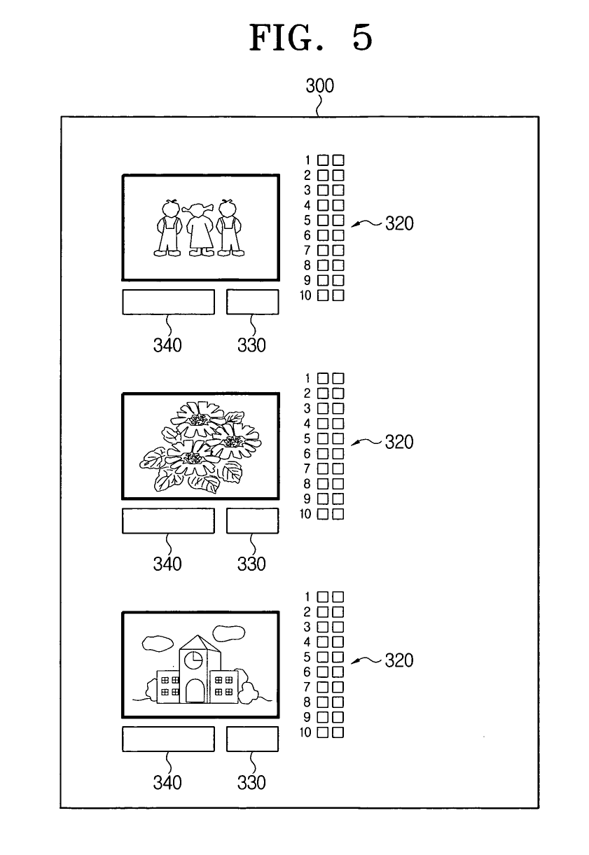

FIG. 5 shows another example of thumbnail data allocated and displayed with an identification code and additional information, respectively, according to an embodiment of the present invention. As shown in FIG. 5, location information 340 and the additional information 320 may be displayed and printed out below and beside the respective image data. The location information 340 may comprise a file path (such as a folder name) which indicates the location of the corresponding file image. As described above regarding the embodiment shown in FIG. 4, the identification code 310 can be comprised of any of the barcode, the file name, and the file location information. According to yet another embodiment of the present invention, the barcode, the file name, and the file location information can all be included in the identification code 310.

Referring again to FIG. 3, the print driver 142 and the printing mechanism 144 operate as the printing part 140.

The print driver 142 controls the driving of the printing mechanism 144 according to the control of the control part 120. The print driver 142 decodes the printing data received from the control part 120 through an internal bus, and generates patterns with respect to images which are to be generated by the printing mechanism 144. The print driver 142 controls the driving of the printing mechanism 144 based on this printing data.

The printing mechanism 144 picks up paper stacked on a paper supply cassette (not shown) sheet by sheet according to a paper feeding signal of the print driver 142, forms an electrostatic latent image on a photoconductive drum (not shown) by scanning a laser beam on the photoconductive drum, supplies a developer to the photoconductive drum having thereon the electrostatic latent image thereby forming a toner image, transfers the toner image onto the supplied paper, and fuses the toner image on the paper by applying heat and pressure. Thus, a desired image is produced.

The host computer 200 transmits the image data for printing as the thumbnail data to the multi-function apparatus 100 by a user's operation substantially as described in regard to the prior art, and the control part 120 adds the identification code 310 and the additional information indication part 320 to the thumbnail data in accordance with an embodiment of the present invention, thereby converting the thumbnail data to the bitmap image data which comprises the printing data, while the print driver 142 controls the driving of the printing mechanism 144 to print out the printing data according to the control of the control part 120.

The reading part 160 comprises a scanner 164, an image processing part 162, and an image memory 166. The scanner 164 scans the image in substantially the same manner as a general scanner, scans the printed image data, and reads and outputs the image data with the identification code 310, the additional information indication part 320, and the file name 330 added thereto. The image processing part 162 compensates the image quality of the image data scanned by the scanner 164, reads the identification code 310, the additional information of the additional information indication part 320, and the file name 330 from the scanned data, and transmits the information to the control part 120. The image memory 166 stores the respectively processed image data and the identification codes 310 corresponding to the respective image data. The image data stored to the image memory 166 is controlled by the control part 120 so as to print out the image data according to a result of the read additional information, such as the number of copies for printing. If the image data is not allocated with the identification code 310 or the file name 330, the image processing part 162 reads the location information and the additional information of the respective image data and transmits the read information to the control part 120. The image memory 166 then stores the respectively processed image data and the location information corresponding to the respective image data.

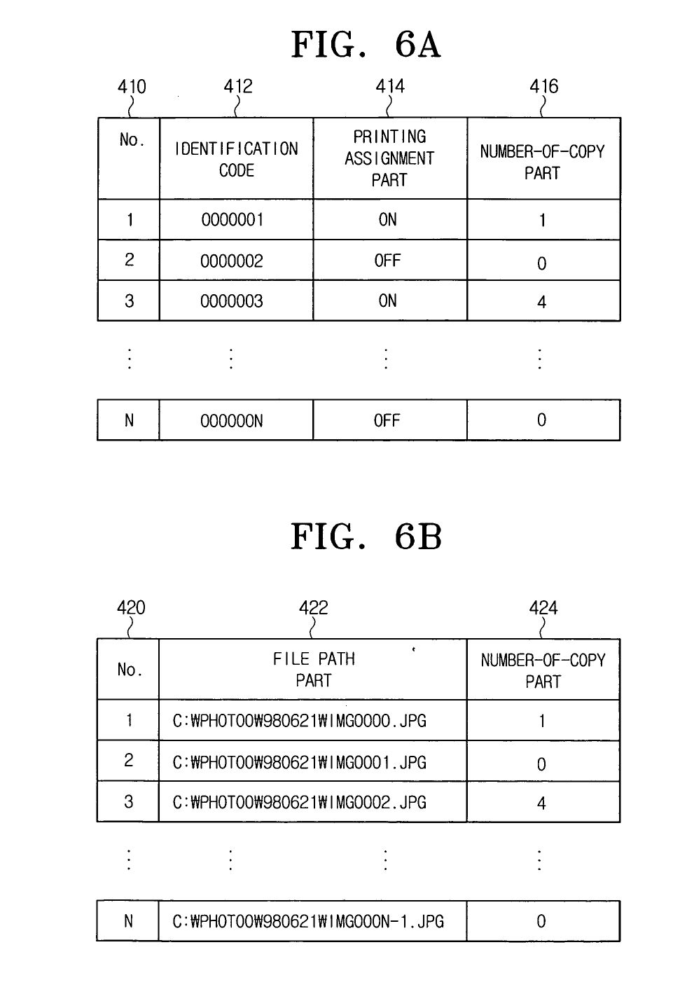

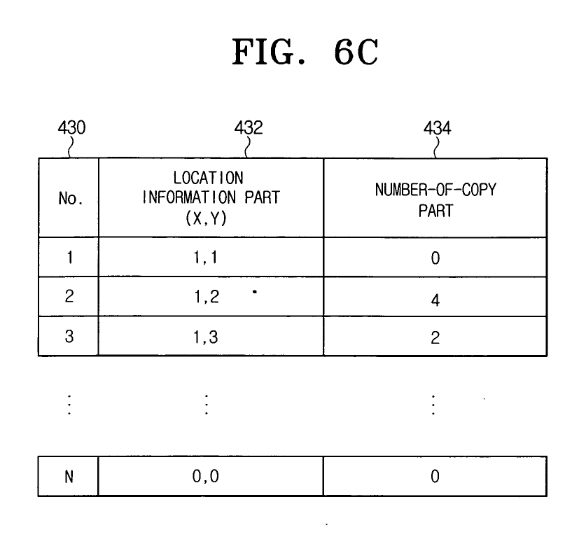

The control part 120 manages the identification codes 310 and the additional information transmitted from the image processing part 162 using a table as shown in FIG 6A. In the table of FIG. 6A, the printed thumbnail data is given numbers 410. Each numbered item of the table may include an identification code part 412 representing the identification code 310, a printing assignment part 414 representing whether the thumbnail image is to be printed or not according to the read result of the additional information indication part 320, and a number-of-copy part 416 representing the number of copies for printing. The printing assignment part 414 and the number-of-copy part 416 may both be recorded in the table according to the read information of the additional information; however, it is preferable that the number-of-copy part 416 be tabulated for each numbered item so that printing is performed with respect to only the thumbnail data recorded with a number of copies for printing.

That is, the control part 120 checks the printing assignment state and the number of copies of the respective thumbnail data, and controls the multi-function apparatus 100 so as to print out the images in order of the number 410 stored in the table.

When the file path is used as the location information as shown in FIG. 6B, the thumbnail data is given numbers 420, and each numbered item includes a file path part 422 representing the file path and a number-of-copy part 424.

When the control part 120 stores only the initially selected location information as shown in FIG. 6C, the respective thumbnail data is given numbers 430, and a location information part 432 and a number-of-copy part 434 may be tabulated for each numbered item. For example, the thumbnail data shown in FIG. 4 can have the location information recorded in the location information part 432, wherein the coordinate (x, y) is (1, 3).

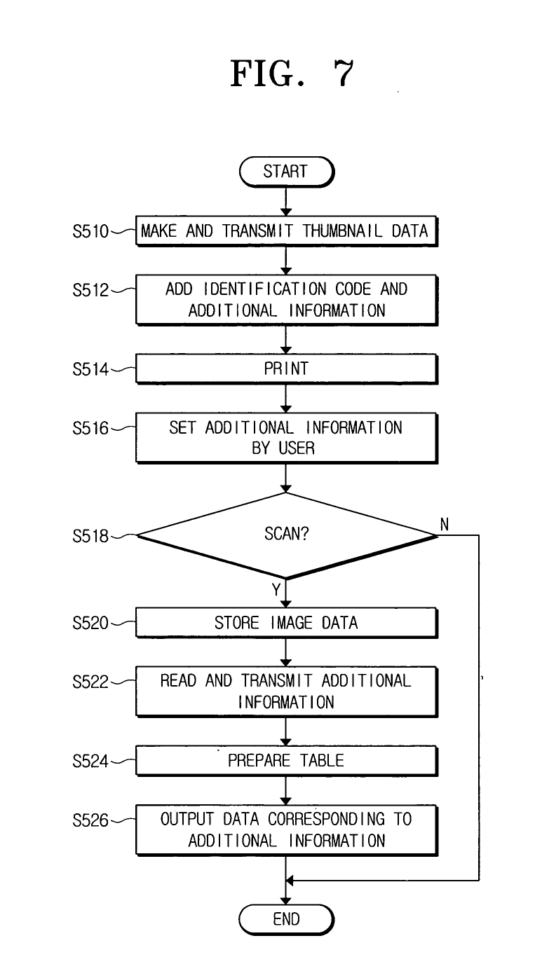

Hereinbelow, a printing method according to an embodiment of the present invention will be described in greater detail with respect to FIG. 7.

In the method of FIG. 7, the host computer 200 first prepares and transmits the thumbnail data for printing to the multi-function apparatus 100 at step (S510). The thumbnail data is transmitted through the interface 110 to the control part 120 of the multi-function apparatus 100 which executes programs for generating the identification code 310 and for displaying the additional information, which are stored to the memory part 130, and records the identification code 310 below the respective image data. The control part 120 also displays the additional information indication part 320 for the user to set the additional information, such as the number of copies for printing by marking therein, and creates the bitmap image data at step (S512). In addition, the control part 120 drives the print driver 142 to control the print mechanism 144 to then print out the image data at step (S514).

In the case wherein the initially selected location information is used in step (S512), the image data may be provided with the additional information indication part 320 displayed on the right thereof by only operating the additional information displaying programs.

When the additional information indication part 320 is set by the user with respect to the printed image data at step (S516), the control part 120 controls the scanner 164 to scan the image data including the identification code 310 and the additional information indication part 320 at step (S518). The image processing part 162 reads the identification code 310 and the additional information from the scanned data, stores the image data according to the identification code 310 to the image memory 166 at step (S520), and transmits the read identification codes 310 and additional information 320 to the control part 120 at step (S522).

The control part 120 prepares a table (such as the table of FIG. 6A) for managing the image data, referring to the additional information corresponding to each identification code 310 at step (S524). When the table is completed, the control part 120 controls the printing part 140 so as to read the corresponding files from the image memory 166 according to the additional information and print out the read files at step (S526).

As can be appreciated from the above description, the files for printing, including the image files, are allocated with the identification code 310 and the additional information indication part 320 and then printed out. Then, the information set or marked in the additional information indication part 320 by the user is read by scanning, and the respective files are processed according to the result of the reading.

Although an embodiment of the present invention has been depicted in which the scanned image is stored to the image memory 166 and output according to the identification code 310 and the additional information in the additional information indication part 320, alternatively, in yet another embodiment of the present invention the control part 120 may store the identification code 310 and the corresponding image to the memory 130 when allocating the identification code 310 and the additional information to the respective image data, and the scanner 164 may read the identification code 310 and the additional information indication part 320 so that the images stored to the memory 130 are printed according to the read additional information. That is, the images can be stored to either the memory part 130 or the image memory 166.

The exemplary structures of the multi-function apparatus have been described as examples only, and the present invention can be adapted to any number of devices having a scanning function.

For example, in a case wherein a fax function and a mail function are additionally provided to the multi-function apparatus, the additional information indication part 320 may further comprise blanks for setting a faxing time, a reservation time for faxing, and other options for sending mails.

According to the exemplary printing method and printing apparatus of the present invention, the selection of specific files from among a mass of files stored to the host computer 200 such as the PC, and a digital camera, is facilitated, and the selected files can be separately processed according to the dedicated information thereof. Especially in the case wherein a plurality of the files are to be separately printed by more than one user, the selection of the images becomes easy through the printed thumbnail data.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A printing method comprising the steps of:
printing out an image and image printing information including an additional information indication part for designating certain additional information and a discernable identification code;
displaying the image and the additional information in the additional information indication part;
reading the additional information and the discernable identification code; and
printing out the image being discriminated by the discernable identification code according to the additional information.

2. The method of claim 1, wherein the discernable identification code comprises at least one of an image file name and a file path.

3. The method of claim 1, wherein the discernable identification code comprises an image location information initially selected.

4. The method of claim 1, wherein the discernable identification code comprises a barcode.

5. The method of claim 1, wherein the displaying step comprises a step of selecting one of a plurality of user configurable options.

6. The method of claim 5, wherein the plurality of user configurable options comprises a number of copies for printing of the image.

7. The method of claim 4, wherein the reading step comprises a step of scanning at least one of the additional information and the barcode.

8. A printing apparatus comprising:
a printing part for printing out an image and image printing information including an additional information indication part for designating additional information and a discernable identification code;
a reading part for reading the additional information and the discernable identification code; and
a control part for printing out the image being discriminated by the discernable identification code according to the additional information.

9. The apparatus of claim 8, wherein the discernable identification code comprises at least one of a file name and a file path.

10. The apparatus of claim 8, wherein the discernable identification code comprises an image location information initially selected.

11. The apparatus of claim 8, wherein the discernable identification code comprises a barcode.

12. The apparatus of claim 8, wherein the additional information indication part is configured to select and display one of a plurality of user configurable options.

13. The apparatus of claim 12, wherein the plurality of user configurable options comprise a number of copies for printing of the image.

14. The apparatus of claim 11, wherein the reading part is configured to perform at least one of a scanning of the additional information and a scanning of the barcode.
